(19) United States
(12) Patent Application Publication
(10) Pub. No.: US 2024/0257470 A1
(43) Pub. Date: Aug. 1, 2024

(54) AVATAR PERSONALIZATION USING IMAGE GENERATION

(71) Applicant: Meta Platforms Technologies, LLC, Menlo Park, CA (US)

(72) Inventors: Sonal Gupta, Sunnyvale, CA (US); Samaneh Azadi, Belmont, CA (US); Mian Akbar Shah, San Carlos, CA (US); Thomas Falstad Hayes, San Francisco, CA (US); Devi Niru Parikh, San Francisco, CA (US)

(21) Appl. No.: 18/458,731

(22) Filed: Aug. 30, 2023

Related U.S. Application Data
(60) Provisional application No. 63/482,288, filed on Jan. 30, 2023.

(51) Int. Cl. G06T 19/00; G06F 40/40

(52) U.S. Cl. CPC G06T 19/00; G06F 40/40

(57) ABSTRACT

A method and system for personalized avatar generation. The method includes receiving a text prompt and generating a first pose based on the text prompt using a first model. The method also includes re-targeting the first pose to a target avatar body. The method also includes identifying a predefined avatar configuration corresponding to a user based on a profile of the user. The method also includes converting the target avatar body by applying the predefined avatar configuration to the target avatar body. The method also includes rendering an avatar, using a second model, based on the target avatar body with the predefined avatar configuration, wherein the avatar is in the first pose.

### CROSS-REFERENCE TO RELATED APPLICATIONS

This present application claims the benefit of priority under 35 U.S.C. § 119(e) to U.S. Provisional Application No. 63/482,288, filed Jan. 30, 2023, the disclosure of which is hereby incorporated by reference in its entirety for all purposes.

### BACKGROUND

### Field

The present disclosure is generally related to improving avatar personalization in a virtual environment. More specifically, the present disclosure includes generating avatar poses based on text prompts by leveraging large scale image/video datasets to enable zero-shot personalization of avatar appearances.

### Related Art

As social media and gaming has expanded social life into the online medium, virtual presentation of users (such as avatars) have become increasingly focal to social presence, self-expression through visual features (such as stickers and avatars), and with that, the demand of avatar personalization. Avatars are a befitting method for personalization as they enable users to inject their identity into an expressive virtual self, while mitigating deepfake and privacy concerns. However, in related art, expressions are limited to a set of predefined stickers and avatars created by designers, and thus limit the personalization of avatars and user experience through social media. For example, text-to-image generation models may be personalized by fine-tuning on a few instances of a subject. However, this method is not scalable to millions of users due to high computing/processing costs required for fine-tuning on each new subject. This method is also unreliable and may result in inaccurate representations of the subject's identity. As such, there is a need to provide users with improved virtual representation personalization capabilities that are applicable across many users, with increased accuracy and faithfulness to the user's identity, and include increased open-world text understanding.

### SUMMARY

The subject disclosure provides for systems and methods for personalized three-dimensional (3D) avatar generation. In one aspect of the present disclosure, the method includes receiving a text prompt, generating a first pose based on the text prompt using a first model, re-targeting the first pose to a target avatar body, identifying a predefined avatar configuration corresponding to a user based on a profile of the user, converting the target avatar body by applying the predefined avatar configuration to the target avatar body, and rendering an avatar, using a second model, based on the target avatar body with the predefined avatar configuration, wherein the avatar is in the first pose.

Another aspect of the present disclosure relates to a system configured for personalized avatar generation. The system includes one or more processors, and a memory storing instructions which, when executed by the one or more processors, cause the system to perform operations. The operations include to receive a text prompt describing a scene and interactions of the avatar within the scene, generate a first pose based on the text prompt using a first model, re-target the first pose to a target avatar body, identify a predefined avatar configuration corresponding to a user based on a profile of the user, convert the target avatar body by applying the predefined avatar configuration to the target avatar body, and render an avatar, using a second model, based on the target avatar body with the predefined avatar configuration, wherein the avatar is in the first pose.

Yet another aspect of the present disclosure relates to a non-transient computer-readable storage medium having instructions embodied thereon, the instructions being executable by one or more processors to perform a method(s) for personalized avatar generation and cause the one or more processors to receive a text input describing an avatar in a scene, generating a body pose based on the text prompt, re-targeting the body pose to a target avatar body, generating a personalized avatar based on a predefined avatar configuration being applied to the target avatar body, and generating an image of the avatar in the scene based on the personalized avatar, the image including the avatar being in the generated body pose with the predefined avatar configuration.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a diagram of an environment 100 in which methods, apparatuses and systems described herein may be implemented, according to some embodiments.

FIG. 2 is a block diagram illustrating an overall framework of a system, according to some embodiments.

FIG. 3 is an exemplary model architecture of the text-3D-pose generation model, according to embodiments.

FIG. 4 illustrates various examples of a qualitative comparison of the text-3D-pose generation model, according to some embodiments.

FIG. 5 illustrates an example block diagram of a system for personalized avatar 3D pose generation, according to some embodiments.

FIG. 6 is a flowchart of a method for personalized avatar 3D pose generation, according to some embodiments.

FIG. 7 is a block diagram illustrating a computer system used to at least partially carry out one or more of operations in methods disclosed herein, according to some embodiments.

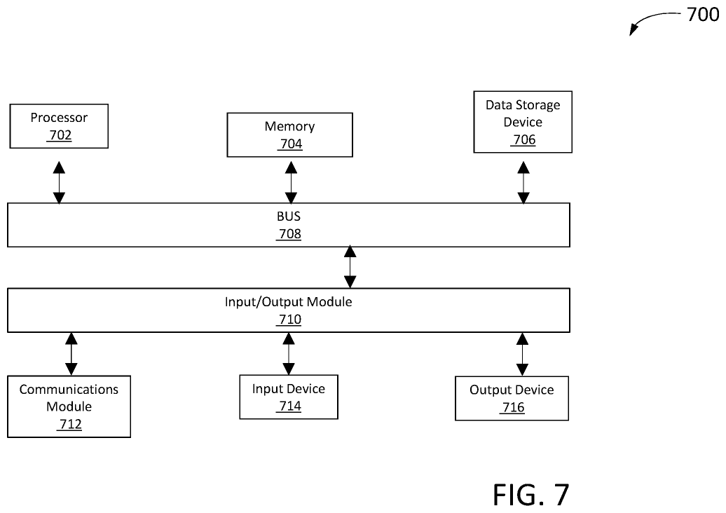

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Personalization and self-expression may be expressed through visual features in social media, virtual reality/augmented reality/mixed reality (VR/AR/MR) applications, and the like. Avatars are a befitting method for personalization as they enable users to inject their identity into an expressive virtual self, while mitigating deepfake and privacy concerns. Avatars (or other motion characters) represented using text-to-motion models trained on motion capture datasets are limited in diversity. With current technology, however, one's expression is limited to a set of predefined stickers, features, and avatars (pre-created). Varying image personalization methods suffer from poor faithfulness to user's identity, lacking open-world text understanding, and/or are not scalable to large application groups.

Embodiments of this disclosure describe Personalized Avatar Scene (PAS) which is a scalable method for zero-shot personalization of image generation that can produce images with a user's personal avatar from a text prompt. The avatar image generation, according to embodiments, is agnostic to avatar texture and style and remains faithful to the avatar appearance without requiring fine-tuning or training on the user's avatar. Accordingly, methods and systems according to embodiments are easily scalable to millions of users. To render a 3D avatar in a pose faithful to a given input text (or text prompt), embodiments describe a pose generation model that utilizes large image and video datasets to learn human 3D representations without relying on expensive human motion capture datasets to generate a 3D pose (or image of a 3D pose). A sequence of the 3D poses are used to demonstrate motion of an avatar or the like. Specifically, human motion may be represented as a sequence of 3D SMPL body parameters, with a 6D continuous SMPL representation for 21 body joints and the root orient.

PAS is trained in two stages: (1) training a text-conditioned static 3D pose generation diffusion model (i.e., pose generation model) on the TPP dataset, (2) the pre-trained diffusion model is extended to motion generation via the addition of temporal convolution and attention layers which model the new temporal dimension and train on motion capture data. In the first stage, PAS learns the distribution of human poses and their alignment with text. In the second stage, the model learns motion, i.e., how to connect poses in a temporally coherent manner.

According to embodiments, the pose generation model is trained on a curated large-scale dataset of in-the-wild human poses extracted from image-text datasets. improving upon the performance of other text-to-motion models significantly. Large-scale image datasets are leveraged to learn human 3D pose parameters and overcome limitations of motion capture datasets. The pose generation model learns to map diverse human poses to natural language descriptions through the image-text datasets, rather than being limited to motion capture data as conventionally done.

According to embodiments, a human body pose is generated from the input text and an avatar is rendered in the generated pose. The generated pose is re-targeted to the avatar body enabling every user to render their own avatar in the target generated pose. Finally, an image of the avatar contextualized in a scene is generated using an image generation model conditioned on the input text (e.g., describing the avatar's action and the scene) and the rendered avatar. Re-targeting a predicted pose to an avatar body, and then rendering a user's avatar, allows the avatar to maintain strict faithfulness to the context and appearance. The pose generation model provides zero-shot capabilities by learning to faithfully place a rendered avatar into a scene, regardless of the avatar's style, degree of photo-realism, or context of the scene. As such, the pose generation model does not require retraining when a user's personal avatar style or appearance changes.

According to embodiments, an avatar body pose may be represented via 3D Skinned Multi-Person Linear Model (SMPL) parameters. Embodiments learn human 3D pose parameters, perform text-to-3D pose generation with a Transformer-based diffusion model, and then retarget a generated pose onto the avatar body to be rendered. SMPL is a realistic 3D model of the human body that is based on skinning and blend shapes and is learned from thousands of 3D body scans. The pose generation model is trained on a large-scale dataset of human poses (e.g., text-pose pairs) constructed by extracting 3D pseudo-pose SMPL annotations from image-text datasets. According to embodiments, a large-scale Text Pseudo-Pose (TPP) dataset is extracted from the image-text datasets filtered for images containing humans. The large-scale TPP dataset helps to overcome the limited diversity of existing motion capture datasets, in terms of both pose and text diversity, and demonstrates that dataset preparation required for human motion generation can be significantly simplified. By representing avatar body poses via 3D SMPL, the pose generation model is easily adaptable to a number of rendering engines to personalize with the user's avatar appearance. After rendering the avatar in a pose that aligns with the text prompt, the avatar is contextualized in a scene by leveraging a large-scale text-to-image generation model to outpaint from the avatar. In some embodiments, a stable diffusion model is finetuned on an image dataset with corresponding human masks and pseudo-pose annotations to generate images more faithful to the user's personal avatar appearance. As such, the zero-shot personalized image generation of PAS improves faithfulness to the user's virtual identity relative to baselines by injecting human body priors.

Human motion may be represented as a sequence of 3D SMPL body parameters, with a 6D continuous SMPL representation for 21 body joints and the root orient. A global position of a body (e.g., avatar) per frame may be represented via a 3D vector indicating the position in each of the x, y, z dimensions. According to embodiments, human motion generation leverages a language model pretrained on large-scale language data and naturally extends a static text-to-pose generation diffusion model to motion generation via the addition of temporal convolution and attention layers.

Embodiments, as disclosed herein, provide a solution rooted in computer technology and arising in the realm of computer networks, namely generating personalized avatar representations using a text-to-3D pose diffusion model. The disclosed subject technology facilitates more expressive body movements, utilizes any existing 3D rendering engines, and enable a high-quality zero-shot personalization of avatars and motion generation. Accordingly, improving the technological field of image generation as well as user experience by producing quality, faithful images.

### Example Architecture

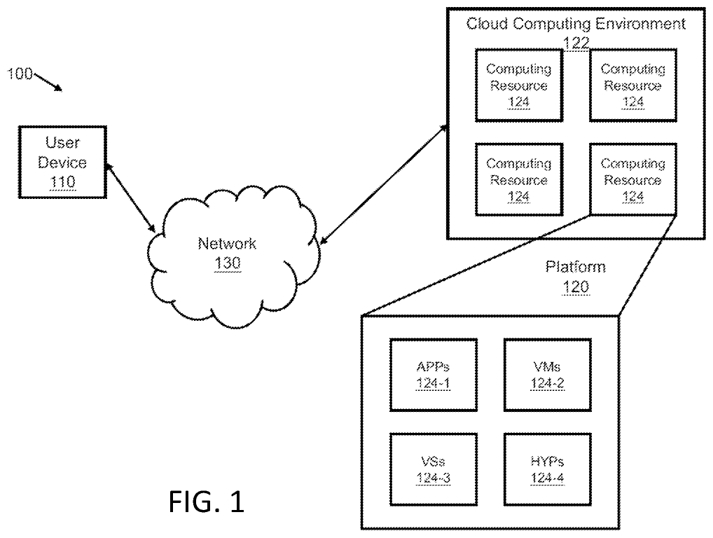

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a headset or other wearable device (e.g., virtual reality or augmented reality headset, smart glasses, a smart watch), or a similar device. In some implementations, the user device 110 may receive information from and/or transmit information to the platform 120 via the network 130.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, data storage (e.g., a database), etc., services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The computing resource 124 may include an application programming interface (API) layer, which controls applications in the user device 110. API layer may also provide tutorials to users of the user device 110 as to new features in the application. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2. The application 124-1 may include one or more modules configured to perform operations according to aspects of embodiments. Such modules are later described in detail.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. Virtualized storage 124-3 may include storing instructions which, when executed by a processor, causes the computing resource 124 to perform at least partially one or more operations in methods consistent with the present disclosure. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems and may manage the execution of the guest operating systems. Multiple instances of a variety of operating systems may share virtualized hardware resources.

The network 130 can include, for example, any one or more of a local area network (LAN), a wide area network (WAN), the Internet, and the like. Further, network 130 can include, but is not limited to, any one or more of the following network topologies, including a bus network, a star network, a ring network, a mesh network, a star-bus network, tree or hierarchical network, and the like.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

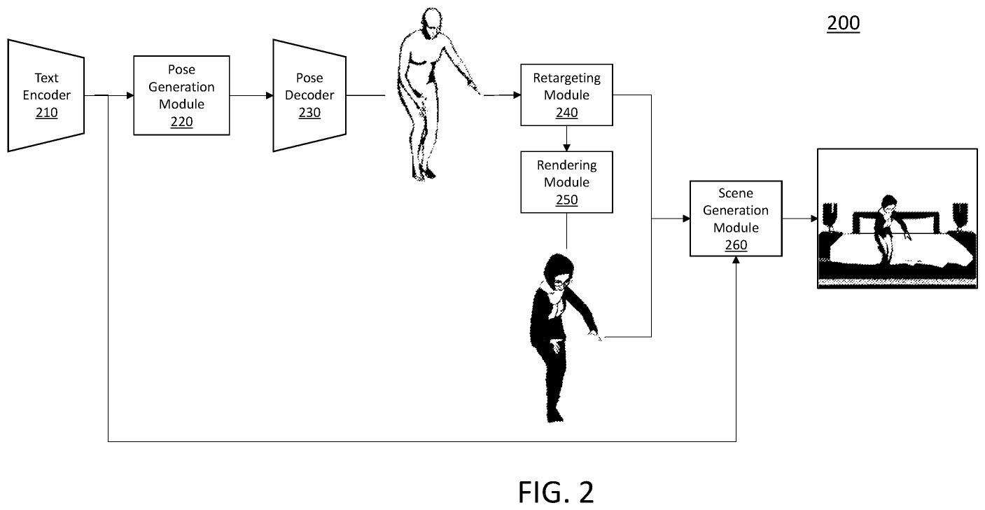

FIG. 2 is a block diagram illustrating an overall framework of a Personalized Avatar Scene (PAS) system 200, according to one or more embodiments. The system 200 may include aspects for training and inference stages of one or more models included in therein. The system 200 may include computing platform(s) that may be configured by machine-readable instructions. Machine-readable instructions may include one or more instruction modules. The instruction modules may include computer program modules. The instruction modules may include one or more of a text encoder 210, pose generator 220, pose decoder 230, retargeting module 240, rendering engine 250, scene generator 260, and/or other instruction modules.

In some implementations, one or more of the modules 210, 220, 230, 240, 250, and 260 may be included in the user device 110 and performed by one or more processors. In some implementations, one or more of the modules 210, 220, 230, 240, 250, and 260 may be included in the cloud computing environment 122 and performed via the platform 120. In some implementations, one or more of the modules 210, 220, 230, 240, 250, and 260 are included in and performed by a combination of the user device and the cloud computing environment.

Given an input text prompt, the text encoder 210 is a trained encoder configured to encode the input text prompt. The encoded text prompt is input to the pose generator 220.

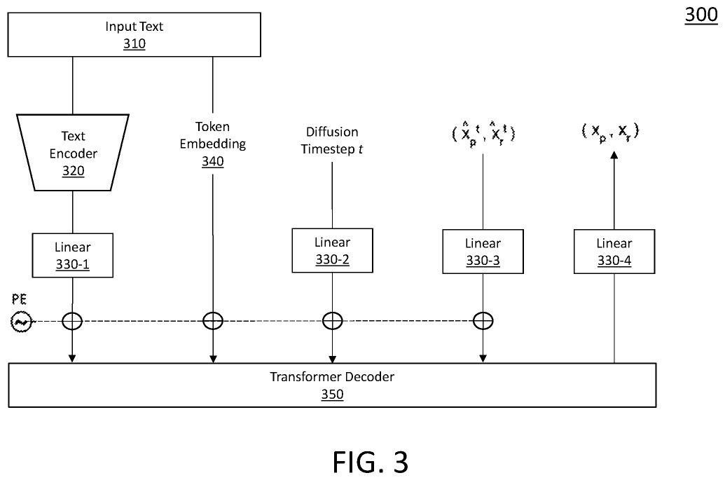

The pose generator 220 generates a 3D body pose using a text-3D-pose (diffusion based) generation model. In some implementations, the text-3D-pose generation model maps text embeddings y from a pre-trained Contrastive Language-Image Pretraining (CLIP) model to the concatenation of continuous body pose representations and root orients. According to embodiments, the text-3D-pose generation model may be based on a decoder-only Transformer with a causal attention mask operating on a sequence of the tokenized captions and their CLIP text embeddings, a diffusion time-step embedding, the noised body pose and root orient representations (\hat{x}ₚ^{t}, \hat{x}ᵣ^{t}), and two final pose and orientation queries to predict the un-noised pose and root orientation (xₚ, xᵣ), respectively. The text-3D-pose generation model may be a pose generation model trained on a large-scale dataset(s) (e.g., Image TPP (ITPP) dataset, HumanML3D test set, etc.) containing human poses and their text descriptions (3D pose and text pairs). This large-scale dataset provides a wide variety of human poses and a huge number of (text, 3D pose) sample pairs. During training, the text-3D-pose generation model may process images to identify images with humans, then extract 3D pseudo-pose SMPL annotations of the human. A text-3D-pose generation model according to one or more embodiments is further detailed with reference to FIG. 3.

The pose generated by the pose generator 220 is input to the pose decoder 230. The pose decoder 230 decodes the pose. In some implementations, the decoded pose is represented via 3D SMPL parameters.

The retargeting module 240 re-targets or re-poses the decoded pose to a target avatar body. That is, the generated pose is applied to the target avatar body. The target avatar body is a reference body representation which may be adapted depending on the user and the generated 3D pose. In some implementations, the target avatar body is a gray avatar-human body representation. Given the generated 3D pose, the retargeting module 240 may retarget the pose by converting the generated 3D pose to a target avatar pose through an optimization process which matches corresponding joints, between the target avatar body and the generated pose, in position and orientation.

The rendering engine 250 renders an image of a posed avatar, based on the generated pose in line with the text prompt, using a text-to-image generation model. For example, the text-to-image priors may be generated using a latent stable diffusion text-to-image generation model (hereafter “personalized image generation model”). The posed avatar is the target avatar body in the generated pose (or target pose) with a user's personal avatar configuration. The appearance of the user's avatar is applied (or copied) onto the target avatar body, enabling any user to render their own avatar in the generated pose. The rendered image may be an RGBA image. An avatar image is rendered in a target pose (e.g., the pose generated by the pose generator 220) based on the converted pose and the personalized avatar configuration, including its shape and texture.

According to embodiments, to perform zero-shot personalization given the generated 3D pose, an image of a posed avatar is rendered using the target avatar body as a reference input. In order to personalize image generation in the system 200 with high-quality user avatars, the retargeting module 240 uses an internal avatar representation (i.e., the target avatar body) and rendering engine 250. Thus, the system 200 may be used for varied avatar types and is not restricted to SMPL-based avatars. According to embodiments, the retargeting module 240 and rendering engine 250 are also “zero-shot” because they do not need any training or prior knowledge of users' avatar configuration to generate an image of an avatar in accordance with the input text prompt.

The scene generator 260 generates a personalized image of a user's avatar in a scene corresponding to the input text. In some implementations, the personalized image includes the users' avatar interacting with objects in the scene. The scene generator 260 may utilize the personalized image generation model to generate the image of the user's avatar and/or the scene including the avatar. Given a rendered image of a posed avatar and text prompt describing the scene and interactions, the scene generator 260 performs conditional stable diffusion inpainting to generate a personalized image by outpainting from the avatar to fill in the rest of the scene and objects. The personalized image generation model is conditioned on the rendered avatar in the target pose as well as the input text prompt describing the avatar's action and the scene. Using a gray human body representation as the target avatar body as reference improves the personalized image generation model's understanding of the human body orientation and limb positioning, providing more accurate human body images.

According to some embodiments, the rendered image (from the rendering engine 250) of the posed avatar may be pasted onto the generated image (from the scene generator 260) in a post-processing step.

According to embodiments, hand and face pose parameters are added to the text-3D-pose generation model as additional targets for the retargeting module 240. As such, embodiments may also control hand poses and facial expressions via the input text prompt, enabling greater expression through rendered avatars. In this manner, a personalized image of a user's avatar may include personalized pose, facial expression, hand movement, etc., generated based on an input text prompt.

In some implementations, the personalized image generation model trains a convolutional neural network (UNet) on a learned latent space of an image autoencoder. The image autoencoder may be conditioned on a timestep t and CLIP text encodings (or embeddings). The personalized image generation model is trained on a large-scale image-text dataset (e.g., ITPP dataset of full body humans), thus having a vast open-world visual textual understanding. Embodiments may include, when training one or more models described herein, using segmentation (e.g., panoptic segmentation) to crop out humans in the dataset for conditioning and training the UNet on the cropped humans. During inference (testing), the UNet is conditioned on the image of the avatar rendered in the pose generated by the text-3D-pose generation model. By operating the personalized image generation model in the compressed latent space rather than, e.g., a pixel space, the personalized image generation model is more efficient than other large-scale text-to-image generation models. Additionally, the personalized image generation model, according to embodiments, does not require a super-resolution step or the like to generate high resolution images.

According to embodiments, the UNet may also be conditioned on a gray body rendering of the generated 3D pose. This injects human body priors into the personalized image generation model so it can generate more realistic avatar-object interactions. Conditioning on the gray body render of the generated 3D pose also helps bridge the gap between humans (during training) and avatars (during testing) since gray body renders are the same for each. In some implementations, the UNet conditioning may be augmented by downsampling the spatial dimensions and conditioning the UNet on the downsample factor. This helps the personalized image generation model be less sensitive to the avatar's appearance when stylizing the image since downsampling removes texture details in the conditioning, improving the model's faithfulness to the avatar's appearance.

According to embodiments, a full set personalization conditioning of the UNet may include conditioning on the text describing the scene (i.e., text input) and avatar-object interaction (y), the rendered (RGBA) image (p) of the avatar in the target pose, the personalization downsample rate (w), and the timestep (t). The full set personalization conditioning of the UNet (of the personalized image generation model) may be learned via the latent diffusion model loss L_{LDM}, which may be represented as:

$${ℒ}_{L D M} = {𝔼}_{ε ( x ) , y , p , w \sim [ 0 , 1 ] , ϵ \sim N ( 0 , 1 ) , t \sim [ 1 , T ]} [ {‖ ϵ - {ϵ}_{θ} ( {z}_{t} , t , y , p , w ) ‖}_{2}^{2} ] \qquad Equation ( 1 )$$

To condition the UNet on an RGBA image p, ε(x) is used to encode the RGB channels to zₚ and concatenate zₚ onto zₜ along the channels' dimension. The α channel is separately downsampled to the spatial dimensions of z (64×64) and concatenated along the channels' dimension. To condition on the augmentation personalization downsample rate w, the personalization downsample rate w is encoded using a sinusoidal embedding, projected to the dimensions of the CLIP text encodings, and concatenated with text encodings for cross-attention.

Embodiments may include avatar motion generation via a motion diffusion model using the UNet architecture. As described, the rendered avatar body pose, P, may be represented via 3D SMPL body parameters and an avatar motion as a sequence of body poses for N frames, [P₁, P₂, . . . , P_{N}]. 6D continuous SMPL representation may be used for 21 body joints and the root orients, including the global position per frame represented via a 3D vector indicating the avatar's position in each of the x, y, z dimensions, resulting in each Pᵢ∈ [symbol] ¹³⁵. Avatar motion generation, according to embodiments, is built from three major components: (1) a pre-trained language model trained on a large-scale language data (2) the pose generation model (trained on the ITPP dataset), and (3) a set of temporal convolution and attention layers extending the pose generation model to the temporal dimension for motion generation and capturing the dependencies between the frames. Vector (v)-prediction parameterization (vₜ=αₜϵ−σₜx) is used to train the pose and motion diffusion models for numerical stability. Denoising is implemented in the UNet architecture on all motion frames at the same time resulting in a higher temporal coherence in the generated avatar motions and does not require any specific loss on the motion velocity for smooth motion synthesis. The motion diffusion model also benefits from classifier free guidance at inference by conditioning the motion diffusion model on a null text during training for a predetermined amount of time (e.g., 10% of the time).

FIG. 3 is an exemplary model architecture 300 of the text-3D-pose generation model, according to embodiments. The model architecture 300 includes input text 310. The input text 310 may be a series of characters, a phrase, or a description for a desired pose, scene, or context surrounding an avatar. The input text 310 is encoded at the text encoder 320 and generates text embeddings through a linear layer 330. The linear layer 330 may collectively refer to at least one of linear 330-1, 330-2, 330-3, and 330-4. The text-3D-pose generation model is a UNet based diffusion model trained on a large-scale dataset of human poses to generate 3D SMPL pose parameters conditioning on text embeddings. Text embedding may be from, for example, a large frozen language model.

An input sequence to the model architecture 300 includes text embedding y, tokens embedding 340, the diffusion timestep f, and noised pose and root orient representations (\hat{x}ₚ^{t}, \hat{x}ᵣ^{t}) all projected to a transformer dimension to be decoded by the transformer decoder 350. The text embeddings y may be CLIP text embeddings. The pose generation inputs may further include batch size B and channel dimensions C (e.g., the channel dimension may be 135). The UNet of the model may be build from a sequence of (1) residual blocks with 1×1 2D-convolution layers conditioned on the diffusion time-step t embedding and text embedding, and (2) Attention Blocks attending to the textual information and the diffusion time-step t. During training (on the ITPP dataset), translation parameters may be set to zero in all training examples (i.e., setting a human at the center of the scene).

In some implementations, the positional embedding is added to each token in the above sequence. The un-noised pose and root orient representations (xₚ, xᵣ) are predicted at each timestep during training.

The text-3D-pose generation model may be trained to directly predict the un-noised pose and root orientation using a mean-squared error loss L_{MSE}, which may be represented as:

$${ℒ}_{M S E} = {𝔼}_{t \sim [ 1 , T ] , {x}_{p} \sim {q}_{p} , {x}_{r} \sim {q}_{r}} {‖ {f}_{θ} ( ( {x}_{p}^{( t )} , {x}_{r}^{( t )} ) , t , y ) - ( {x}_{p} , {x}_{r} ) ‖}^{2} \qquad Equation ( 2 )$$

where y is the avatar-object interaction.

According to embodiments, an avatar body pose may be represented via 3D SMPL parameters. The system 200 may learn to predict the avatar body pose from text via a Transformer-based (diffusion) text-3D-pose generation model, and then retarget the predicted pose to the avatar body which is then rendered. In some embodiments, a pre-trained variational human pose prior (e.g., VPoser) trained from a large dataset of human poses represented as SMPL bodies. The pre-trained variational human pose prior may be used as a Variational Autoencoder to efficiently model the distribution of pose priors instead of learning to generate all 3D joint rotations. The pre-trained variational human pose prior may be configured to learn latent representations of human poses and regularize the distribution of the latent representation to be a normal distribution (e.g., regularize them in the natural distribution of human bodies). The pre-trained variational human pose prior may be in a continuous embedding space which fits well in a gradual noising and denoising diffusion process.

To improve sample quality at inference of the text-3D-pose generation model, embodiments include classifier free guidance implemented by dropping the text conditioning a predetermined amount (e.g., 10% of the time) during training. After training, the body pose encodings generated by the diffusion model to the pre-trained VPoser decoder to generate the 3D SMPL body rotation vectors.

In some embodiments, the pose generation model is expanded to learn the temporal dimension for motion generation. The convolutional and attention layers of the UNet may be modified to include reshaping the input motion sequence to a tensor of shape B×C×N×1×1, where C is the length of the pose representation and N is the number of frames. A 1D temporal convolution layer is stacked (or added) following each 1×1 2D-convolution. In some implementations, temporal attention layers are added after each cross-attention layer in a motion fine-tuning stage. This allows the model to train the new 1D temporal layers from scratch while loading the pre-trained convolution weights from the pose generation model. The kernel size of these temporal convolution layers may be set to three opposed to the unit kernel size of the 2D convolutions. A similar dimension decomposition strategy is applied to the attention layers, where a newly initialized temporal attention layer is stacked to each pre-trained attention block from the pose generation model (i.e., from the UNet). In some implementations, rotary position embeddings are utilized for the temporal attention layers.

Table 1 evaluates text-3D-pose generation according to PAS against text-to-human-motion generation models through human evaluations on 390 crowd-sourced prompts and automatic metrics on the HumanML3D test set. PAS evaluated in Table 1 is trained on the ITPP dataset and HumanML3D train set. Given each text prompt, five poses are generated and rendered according to systems and methods of embodiments. The poses are sorted based on CLIP similarity scores between the rendered avatars as 2D images and the input text prompt to select the best generated sample. To compare each baseline, a motion sequence is generated given a text prompt and the best representative frame is selected based on the frames CLIP similarity scores with the text encoding. Baselines 1-4 may represent, for example, TEMOS (generating human motions from textual descriptions), MotionCLIP (generating motion in CLIP space), AvatarCLIP (text-driven generation), and a motion diffusion model (MDM), respectively.

TABLE 1
PAS vs. Other text-to-human-motion generation models

| Method | Human Eval ↑ | FPD ↓ | CLIPSIM ↑ |
|---|---|---|---|
| Baseline 1 | 73.7 | 4.6 | 0.17 |
| Baseline 2 | 59.0 | 12.06 | 0.145 |
| Baseline 3 | 60.7 | 13.28 | 0.162 |
| Baseline 4 | 60.0 | 11.16 | 0.15 |
| PAS (6D + VPoser) | — | 6.25 | 0.16 |
| PAS (VPoser) | — | 7.27 | 0.164 |

As shown in Table 1, PAS is compared to each method in terms of the correctness of each generated pose given a text prompt. The results are expressed as the percentage of user preference for the text-3D-pose generation model over each baseline on the 390 crowd-sourced prompts. The prompts include a description of an action along with some context of the scene. Fréchet Pose Distance (FPD), computed as the Frèchet distance in the Vposer embedding space, measures overall quality and diversity of the samples. Further, the CLIP similarity (CLIPSIM) score between the rendered avatars corresponding to each generated pose and its textual description is computed to measure pose-text faithfulness. As shown in Table 1, the pose generation model according to embodiments (PAS) is superior in its faithfulness to the input text compared to the other baseline methods.

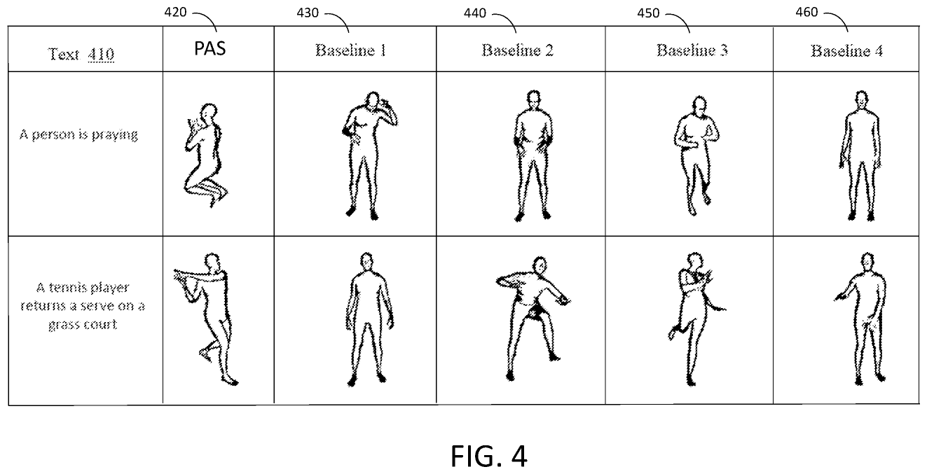

FIG. 4 illustrates various examples of a qualitative comparison of the PAS model vs. the other baselines. The text 410 is the input text prompts. PAS 420 is the output pose rendered from the text-3D-pose generation model according to embodiments. Outputs 430/440/450/460 are the output poses generated by the other text-to-human-motion generation models (i.e., baselines 1-4 in Table 1) based on the text 410. As shown in FIG. 4, the generated poses (PAS 420) show increased faithfulness to the input texts (text 410).

Table 2 shows results of an ablation study performed to understand the impact of different continuous pose representations and training datasets (e.g., 32-dimensional VPoser embedding for the body pose, 6D continuous vectors for all joints, and 6D continuous vectors for all joints regularized by the pre-trained VPoser (described according to embodiments). In the study, the HumanML3D dataset is modified for single frame pose generation. The human evaluation text faithfulness is reported as the percentage of user preference for the last line setting over the others on the curated 390 prompts set (i.e., any value above 50% means 6D+Vposer trained on the ITPP data is favored). For CLIP similarity, SMPL avatars were rendered using the 3D pose predicted by the text-3D-pose generation model according to embodiments.

TABLE 2
Ablation Study Results

| Method | Training data | Human Eval ↑ | CLIPSIM ↑ |
|---|---|---|---|
| 6D + VPoser | HumanML3D | 69.8 | 0.149 |
| 6D | ITPP | 56.6 | 0.146 |
| VPoser | ITPP | 51.5 | 0.150 |
| 6D + VPoser | ITPP | — | 0.149 |

As shown in Table 2, the results confirm the benefit of VPoser representations either in the training of the diffusion model or used as a post regularizer (represented by the last two rows in Table 2). The study also compares the performance of the text-3D-pose generation model, according to embodiments, when trained on the ITPP data vs. trained on the modified HumanML3D dataset for pose generation. This study again confirms the impact of the ITPP dataset compared with the limited existing motion capture datasets by providing a wide range of human actions and training more generalizable motion generation models.

The personalized image generation model of embodiments provides fine-tuning and architecture modifications that improve faithfulness to the avatar's appearance when compared against an outpainting baseline on the crowd-sourced prompts. Table 3 evaluates the personalized image generation model according to PAS against a Stable Diffusion inpainting/outpainting baseline. Table 3 reports human evaluation (avatar and text faithfulness) and automatic metrics (CLIP similarity). The results for human evaluations are reported as the percentage of user preference for outputs according to embodiments over the baseline (i.e., any value above 50% indicates methods of embodiments are favored). The “fine-tuned” method in Table 3 is a Stable Diffusion inpainting/outpainting model (baseline) fine-tuned on the ITPP dataset. This isolates the value of the architecture modifications made according to embodiments.

TABLE 3
PAS vs. Other image generation models

| | Avatar ↑ | Text ↑ | |
|---|---|---|---|
| Method | match | match | CLIPSIM ↑ |
| Stable Diffusion Baseline | — | — | 0.239 |
| Fine-tuned | 0.56 | 0.48 | 0.239 |
| PAS | 0.63 | 0.52 | 0.242 |

As shown in Table. 3, image generation according to PAS shows improvements in faithfulness to the avatar's appearance over related methods/systems. The Stable Diffusion inpainting/outpainting baseline model is trained on random masks, rather than human masks. As such, causing hallucinations of new limbs and articles of clothing, disturbing the avatar's identity. Both the fine-tuning on human body masks and the architecture modifications, as performed according to embodiments, improve faithfulness to the avatar appearance. In particular, according to embodiments, the conditioning of the personalized image generation model on the gray body render improves the model's understanding of the human body orientation and limb positioning to reduce hallucination of new body parts.

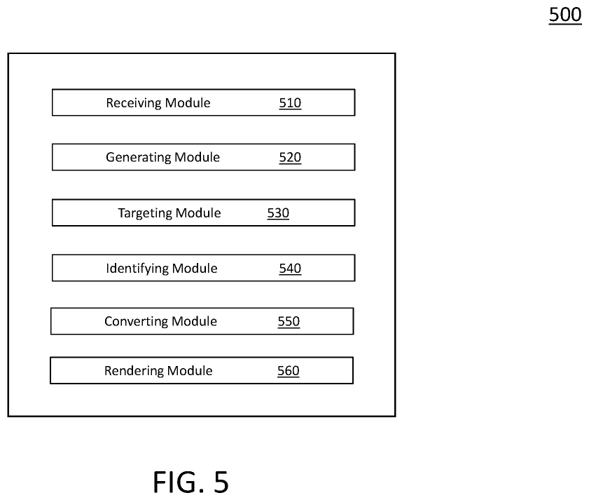

FIG. 5 illustrates an example block diagram of a system 500 for personalized avatar 3D pose generation, according to one or more embodiments. The personalized avatar may be in a virtual environment configured for customization or user interaction. The system 500 may include computing platform(s) which may be configured by machine-readable instructions. Machine-readable instructions may include one or more instruction modules. The instruction modules may include computer program modules. As shown in FIG. 5, the instruction modules may include one or more of a receiving module 510, generating module 520, targeting module 530, identifying module 540, converting module 550, rendering module 560, and/or other instruction modules.

In some implementations, one or more of the modules 510, 520, 530, 540, 550, and 560 may be included in the user device 110. In some implementations, one or more of the modules 510, 520, 530, 540, 550, and 560 may be included in cloud computing environment 122 and performed via the platform 120. In some implementations, one or more of the modules 510, 520, 530, 540, 550, and 560 are included in and performed by a combination of the user device and the cloud computing environment.

The receiving module 510 is configured to receive a text prompt. The system 500 may further include extracting text embeddings from the text input. The text prompt may be encoded using a pre-trained text encoder to generate the text embeddings. The text prompt may describe a scene and interactions of an avatar within the scene.

The generating module 520 is configured to generate a target pose based on the text prompt using a text-3D-pose generation model. The target pose may be a 3D pose generated based on human joint and limb orientation and positioning parameters. In some implementations, the target pose is a human body pose represented by SMPL parameters. To generate the target pose, the text embeddings from the text prompt may be mapped to text embeddings retrieved from a dataset. One or more body poses corresponding to the text embeddings retrieved from the dataset may be selected and the target pose generated based on the selected body poses.

The targeting module 530 is configured to re-target the target pose to a target avatar body. The target avatar body may be, for example, a gray avatar-human body representation used as a baseline for personalization of avatar poses. The targeting module 530 may be further configured to match corresponding joints based on position and orientation from the target pose and the target avatar body to re-target the target pose.

The identifying module 540 is configured to identify an avatar configuration corresponding to a user who submitted the text prompt. The avatar configuration may be predefined on a profile or account of the user.

The converting module 550 is configured to apply the predefined avatar configuration to the target avatar body.

The rendering module 560 is configured to render a personalized avatar image using a personalized image generation model. The personalized avatar image is based on at least the target avatar body, the avatar configuration, and the target pose. As such, the personalized avatar image may be rendered in such a way that an avatar in the image emulates the avatar configuration and is in the generated target pose.

The system 500 may further include one or more modules configured to train the personalized image generation model on a dataset including body poses and corresponding text descriptions. The training may include identifying humans in images of the dataset, segmenting the humans, and extracting SMPL annotations from the segmented humans.

The system 500 may further include one or more modules configured to generate an image of a scene in a virtual environment based on the personalized avatar image and the text prompt using the personalized image generation model. The scene may include the avatar interacting with objects in the scene in accordance with the text prompt. In some implementations, the rendered image of the avatar in the target pose may be overlapped with or a pasted onto the image of the scene. As described, the personalized image generation model may perform conditional stable diffusion inpainting to generate the image by outpainting from the avatar to fill in an existing scene and objects in the existing scene. The personalized image generation model may be conditioned on at least the avatar and the text prompt. In some embodiments, the personalized image generation model is conditioned on the avatar and the text prompt as well as the avatar interactions with objects in the scene, a downsample value, and a timestep.

Although FIG. 5 shows example blocks of the system 500, in some implementations, the system 500 may include additional blocks, fewer blocks, different blocks, or differently arranged blocks than those depicted in FIG. 5. Additionally, or alternatively, two or more of the blocks of the system may be combined.

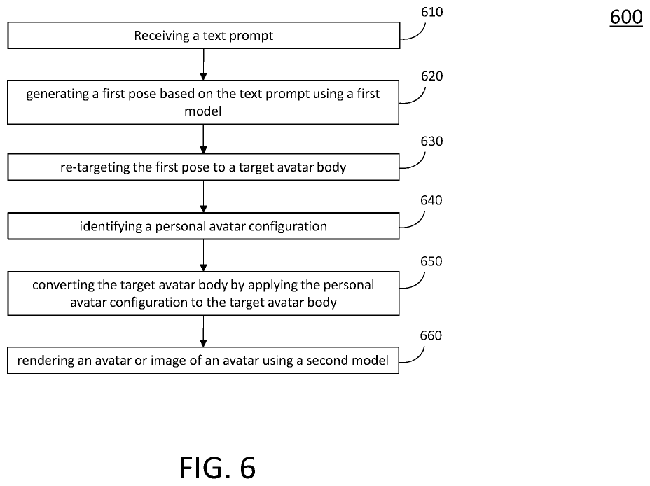

FIG. 6 is a flowchart of a method 600 for personalized avatar 3D pose generation, according to one or more embodiments. The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some embodiments, one or more of the steps in method 600 may be performed by one or more of the modules 510, 520, 530, 540, 550, and 560. In some implementations, one or more operation blocks of FIG. 6 may be performed by a processor circuit executing instructions stored in a memory circuit, in a client device, a remote server or a database, communicatively coupled through a network. In some embodiments, methods consistent with the present disclosure may include at least one or more operations as in method 600 performed in a different order, simultaneously, quasi-simultaneously or overlapping in time.

As shown in FIG. 6, at operation 610, the method 600 includes receiving a text prompt describing a scene and optionally interactions of an avatar within the scene. The method 600 may further include extracting text embeddings from the text prompt.

At operation 620, the method 600 includes generating a first pose based on the text prompt using a first model (e.g., a text-3D-pose generation model). In some implementations, the first pose is a human body pose represented by SMPL parameters. The method 600 may further include mapping the text embeddings extracted from the text prompt to text embeddings retrieved from a dataset (e.g., a CLIP dataset), selecting one or more second poses corresponding to the text embeddings retrieved from the dataset, and generating the first pose based on the selected one or more second poses.

At operation 630, the method 600 includes re-targeting the first pose to a target avatar body. The target avatar body may be, for example, a gray avatar-human body representation used as a baseline for personalizing avatars. The method 600 may further include matching corresponding joints based on position and orientation from the first pose and the target avatar body to re-target the first pose.

At operation 640, the method 600 includes identifying a personal avatar configuration corresponding to a user. The user may be associated with the text prompt (e.g., a user who submitted the text prompt). The personal avatar configuration may be predefined on a profile or account of the user.

At operation 650, the method 600 includes converting the target avatar body by applying the personal avatar configuration to the target avatar body.

At operation 660, the method 600 includes rendering an avatar or image of an avatar using a second model. The avatar is based on at least the target avatar body, the personal avatar configuration, and the first pose such that the avatar is in the first pose.

The method 600 may further include generating an image of a scene in a virtual environment based on the rendered avatar (or avatar image) and the text prompt using the second model. The scene may include the avatar interacting with objects in the scene in accordance with the text prompt.

The method 600 may further include training the second model on a dataset including body poses and corresponding text descriptions. The training may include identifying humans in images of the dataset, segmenting the humans, and extracting SMPL annotations from the segmented humans. The method 600 may even further include performing, via the second model, conditional stable diffusion inpainting to generate the image by outpainting from the avatar to fill in an existing scene and objects in the existing scene. The second model may be conditioned on the avatar and the text prompt. In some embodiments, the second model is conditioned on the avatar and the text prompt as well as the avatar interactions with objects in the scene, a downsample value, and a timestep.

Although FIG. 6 shows example blocks of the method 600, in some implementations, the method 600 may include additional blocks, fewer blocks, different blocks, or differently arranged blocks than those depicted in FIG. 6. Additionally, or alternatively, two or more of the blocks of the method may be performed in parallel.

### Hardware Overview

FIG. 9 is a block diagram illustrating an exemplary computer system 700 with which the user and platform of FIG. 1, and method(s) described herein can be implemented. In certain aspects, the computer system 700 may be implemented using hardware or a combination of software and hardware, either in a dedicated server, or integrated into another entity, or distributed across multiple entities. Computer system 700 may include a desktop computer, a laptop computer, a tablet, a phablet, a smartphone, a feature phone, a server computer, or otherwise. A server computer may be located remotely in a data center or be stored locally.

Computer system 700 (e.g., user device 110 and computing environment 122) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712. Exemplary communications modules 712 (e.g., communications modules 218) include networking interface cards, such as Ethernet cards and modems. In certain aspects, input/output module 710 is configured to connect to a plurality of devices, such as an input device 714 (e.g., user device 110) and/or an output device 716 (e.g., user device 110). Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 716 include display devices, such as an LCD (liquid crystal display) monitor, for displaying information to the user.

According to one aspect of the present disclosure, the user device 110 and platform 120 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, performed by at least one processor, for personalized avatar generation, the method comprising:
receiving a text prompt;
generating a first pose based on the text prompt using a first model;
re-targeting the first pose to a target avatar body;
identifying a predefined avatar configuration corresponding to a user based on a profile of the user;
converting the target avatar body by applying the predefined avatar configuration to the target avatar body; and
rendering an avatar, using a second model, based on the target avatar body with the predefined avatar configuration, wherein the avatar is in the first pose.

2. The computer-implemented method of claim 1, wherein the text prompt describes a scene and interactions of the avatar within the scene.

3. The computer-implemented method of claim 1, wherein the first pose is a 3D pose generated based on human joint and limb orientation and positioning parameters.

4. The computer-implemented method of claim 1, wherein the first pose is a human body pose represented by SMPL parameters.

5. The computer-implemented method of claim 1, the generating the first pose further comprising:
extracting first text embeddings from the text prompt;
mapping the first text embeddings to second text embeddings retrieved from a dataset;
selecting one or more second poses corresponding to the second text embeddings; and
determining the first pose based on the one or more second poses.

6. The computer-implemented method of claim 1, further comprising:
training the first model on a dataset including body poses and corresponding text descriptions, the training comprising:
identifying humans in images of the dataset,
segmenting the humans from the images, and
extracting 3D Skinned Multi-Person Linear Model (SMPL) annotations from segmented humans from the images.

7. The computer-implemented method of claim 1, wherein the target avatar body is a gray avatar-human body representation.

8. The computer-implemented method of claim 1, wherein the re-targeting comprises matching corresponding joints, in position and orientation, from the first pose and the target avatar body.

9. The computer-implemented method of claim 1, further comprising generating an image, using the second model, of a scene in a virtual environment including the avatar interacting with objects in the scene.

10. The computer-implemented method of claim 9, wherein the second model performs conditional stable diffusion inpainting to generate the image by outpainting from the avatar to fill in the scene and objects in the scene, and the second model is conditioned on at least the avatar and the text prompt.

11. A system for personalized avatar generation, the system comprising:
one or more processors; and
a memory storing instructions which, when executed by the one or more processors, cause the system to:
receive a text prompt describing a scene and interactions of the avatar within the scene;
generate a first pose based on the text prompt using a first model;
re-target the first pose to a target avatar body;
identify a predefined avatar configuration corresponding to a user based on a profile of the user;
convert the target avatar body by applying the predefined avatar configuration to the target avatar body; and
render an avatar, using a second model, based on the target avatar body with the predefined avatar configuration, wherein the avatar is in the first pose.

12. The system of claim 11, wherein the first pose is a 3D pose generated based on human joint and limb orientation and positioning parameters.

13. The system of claim 11, wherein the first pose is a human body pose represented by SMPL parameters.

14. The system of claim 11, wherein the one or more processors further execute instructions to:
extract first text embeddings from the text prompt;
map the first text embeddings to second text embeddings retrieved from a dataset;
select one or more second poses corresponding to the second text embeddings; and
determine the first pose based on the one or more second poses.

15. The system of claim 11, wherein the one or more processors further execute instructions to train the first model on a dataset including body poses and corresponding text descriptions, the instructions causing the system to:
identify humans in images of the dataset;
segment the humans from the images; and
extract 3D Skinned Multi-Person Linear Model (SMPL) annotations from segmented humans from the images.

16. The system of claim 11, wherein the target avatar body is a gray avatar-human body representation.

17. The system of claim 11, wherein the one or more processors further execute instructions to match corresponding joints, in position and orientation, from the first pose and the target avatar body.

18. The system of claim 11, wherein the one or more processors further execute instructions to:
generate an image, using the second model, of a scene in a virtual environment including the avatar interacting with objects in the scene.

19. The system of claim 11, wherein the second model performs conditional stable diffusion inpainting to generate an image by outpainting from the avatar to fill in the scene and objects in the scene, and the second model is conditioned on at least the avatar and the text prompt.

20. A non-transient computer-readable storage medium having instructions embodied thereon, the instructions being executable by one or more processors to perform a method for personalized avatar generation and cause the one or more processors to:
receive a text input describing an avatar in a scene;
generating a body pose based on the text prompt;
re-targeting the body pose to a target avatar body;
generating a personalized avatar based on a predefined avatar configuration being applied to the target avatar body; and
generating an image of the avatar in the scene based on the personalized avatar, the image including the avatar being in the body pose with the predefined avatar configuration.
